(19) United States
(12) Patent Application Publication
(10) Pub. No.: US 2009/0301663 A1
(43) Pub. Date: Dec. 10, 2009

(54) REFILL FOR AN ADHESIVE TAPE DISPENSER AND A HOUSING FOR RECEIVING THE REFILL

(75) Inventor: Mads Sandahl Christensen, Tommerup (DK)

Correspondence Address: BROWDY AND NEIMARK, P.L.L.C.;624 NINTH STREET, NW, SUITE 300, WASHINGTON, DC, 20001-5303, US

(73) Assignee: 3L-LUDVIGSEN A/S, Tommerup (DK)

(21) Appl. No.: 12/162,217

(22) PCT Filed: Jan. 23, 2007
(86) PCT No.: PCT/DK2007/050008

§ 371 Date: May 21, 2009

(30) Foreign Application Priority Data
Jan. 25, 2006 (DK) PA 2006 00111

(51) Int. Cl. B65H 37/02; B65H 37/00; B65H 75/18; B32B 37/12

(52) U.S. Cl. 156/577; 242/588.6

(57) ABSTRACT

The refill comprises a base (2) carrying a tubular supply pivot (3) carrying a supply roll (8) of carrier tape carrying adhesive tape, a tubular take-up pivot (4) carrying a take-up roll (12) for spend carrier tape, and an applicator (6) positioned at a front end of the base (2). The supply the applicator (6) and the take-up pivot (4). The carrier tape is extending from a first side of the supply roll (8), to the applicator (6), around the applicator (6), past the other side of the supply roll (8) and to the take-up roll (12) thereby defining a tape area. The base (2) is extending at least at the first side of the supply roll (8) beyond the tape area, and the base (2) is carrying a shielding (7) extending along a part of the first side of the supply roll (8) and a part of a first run (18). Each pivot has an end attached to the base (2) and an opposite free. The refill further comprises a transmission including a slip clutch transmitting a torque from the supply roll (8) to the take-up roll (12). The transmission comprises a first wheel (11), which is coaxial with the supply roll (8), and a second wheel (13) coaxial with the take-up roll (12), wherein said wheels (11, 13) are positioned at the free end of the respective pivot (3, 4).

The present invention relates to a refill for an adhesive tape dispenser, comprising a base carrying a tubular supply pivot, a tubular take-up pivot and an applicator, the applicator being positioned at a front end of the base, the take-up pivot being positioned at an opposite end of the base, and the supply pivot being positioned intermediate the applicator and the take-up pivot, the supply pivot carrying a supply roll of carrier tape carrying an adhesive tape to be dispensed, the take-up pivot carrying a take-up roll for spend carrier tape wherefrom the adhesive tape has been dispensed, the carrier tape extending from a first side of the supply roll, through a first run to the applicator, around the applicator, through a second run to the other side of the supply roll, past said other side and to the take-up roll, the supply roll, the first and second run, the applicator and the take-up roll defining in a projection on a plane parallel to the base a tape area, the base extending at least at the first side of the supply roll beyond the tape area, the base carrying at a part of its edge a shielding extending along a part of the first side of the supply roll and a part of the first run, each pivot having an end attached to the base and an opposite free end, the refill further comprising a transmission transmitting a torque from the supply roll to the take-up roll, said transmission including a slip clutch and said transmission comprising a first wheel, which is coaxial with the supply roll and has a larger radius than the supply roll, and a second wheel coaxial with the take-up roll.

Adhesive tape dispensers are well known in the art, and the adhesive tape may be, also for the present invention, tape pieces provided with adhesive on two sides, adhesive film, highlighting film or film of correction means etc.

Some known dispensers are of a disposal type, whereby the entire dispenser is disposed when all the adhesive tape is spend. This entails a superfluous amount of waste and therefore dispensers have been developed, which comprises a reusable housing containing a refill, which is substituted when the adhesive tape contained therein is spend.

Examples of such housings and refills are given in e.g. U.S. Pat. No. 776,209, U.S. Pat. No. 418,997, U.S. Pat. No. 5,685,944 and EP-A-1 059 258.

In some dispenses comprising a housing and a refill the transmission is provided in the housing, which has the disadvantage that the housing comprises parts, which are worn, and thus the housing must be disposed when those parts are worn out.

Some refills comprise sidewalls (base and top) on both sides of the rolls, which means that the refills comprise quite a lot of material, which is disposed when the refill is disposed.

For the dispenses with refill to be successfully accepted by the users, the change of the refill should be easy and uncomplicated and the user should not be inclined to get in touch with the adhesive during the operation of changing refills.

U.S. Pat. No. 6,776,209, which is considered to disclose the prior art closest to the invention, shows a refill wherein a wheel of the transmission coaxial with the supply roll is positioned between said roll and the base thus making the circumferential surface of the supply roll accessible, though shielding is provided on the peripheral edge of the base.

The object of the present invention is to provide a refill and a housing to contain it, which entails a minimum of waste and provides for easy change of the refill in the housing.

This is obtained in a refill as mentioned in the first paragraph, wherein the wheels are positioned at the free end of the respective pivot. Thereby is obtained that the wheel, which is part of the transmission also serves a function as shielding by covering the circumference of the supply roll where adhesive is present, thus preventing, together with the shielding at the edge of the base, that a user get in touch with the adhesive. This double function, together with the fact that the refill is selfcontained in that it contains as well the necessary rolls as the applicator and the transmission, provides for easy change of refill without risk of contact with the adhesive, and minimizes the need of material for producing the refill.

Though it is known e.g. from the above EP-A-1 059 258 to provide the transmission as a belt drive it is according to the invention preferred to provide the wheels as gear wheels having a circumferential cogging thus avoiding a belt for the belt drive.

The two wheels are preferably intermeshing thus avoiding intermediate idler wheels.

The applicator is preferably made as an independent element attached to the base. Thereby the applicator and the base may respectively be made of the most suitable material.

The applicator is preferably provided with an applicator roll at its distal end for pressing the carrier tape against a substrate to dispense the adhesive tape onto the substrate, said applicator roll having a resilient surface. Such a resilient applicator roll may compensate for irregularities in the substrate onto which the adhesive tape is dispensed.

The first wheel is preferably attached to an inner hub member carrying with a friction fit an outer hub member carrying the supply roll, thus providing the slip clutch.

At least one of the tubular pivots has a tubular wall, said wall being slit from the free end to provide a flexible tongue, and said tongue carrying at a free end an outer projection providing an obstruction for the respective roll. This provides for retaining the roll on its respective pivot even the refill during handling is turned upside down.

According to the present invention a housing is provided for receiving a refill according the invention, said housing comprising two parts, one of which comprises two cylindrical pins for receiving the two pivots and a projection for supporting the applicator. In the case where the a tubular pivot is slit to provide a flexible tongue, which has a projection providing an obstruction for the respective roll, the pin may obstruct deflection of the tongue thereby preventing the roll from leaving the pivot even if the dispenser is subject to an impact.

One of the cylindrical pins may have an outer cylindrical surface having a non-circular cross-section, e.g. provided by an axial protrusion on the cylindrical surface. Correspondingly the corresponding tubular pivot may have an inner cylindrical surface with a non-circular cross-section, e.g. provided by an axial recess in the cylindrical surface. In this way the refill may be dedicated to special housings so that e.g. special housings may be provided for special types of adhesive and carry outer indications of the adhesive contained, and such housings may only be able to receive refills containing the right adhesive, thereby avoiding the confusing situation that a housing with a given outer indication of adhesive actually contains another adhesive.

The invention will be explained in more detail in the following by way of an example of an embodiment with reference to the accompanying drawings, wherein

FIG. 1 is a perspective view of a refill according to the present invention,

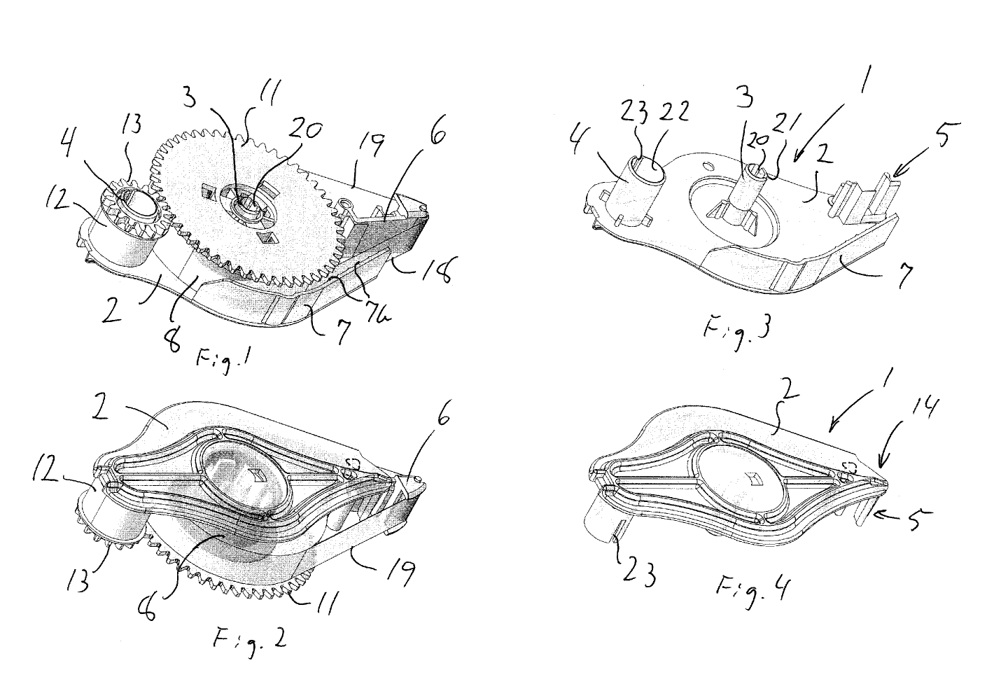

FIG. 2 is a perspective view of the refill of FIG. 1 from another side,

FIG. 3 is a perspective view corresponding to FIG. 1 but showing a base element alone,

FIG. 4 is a perspective view corresponding to FIG. 2 showing the base element alone,

FIG. 5 is a base side view of the refill of FIG. 1,

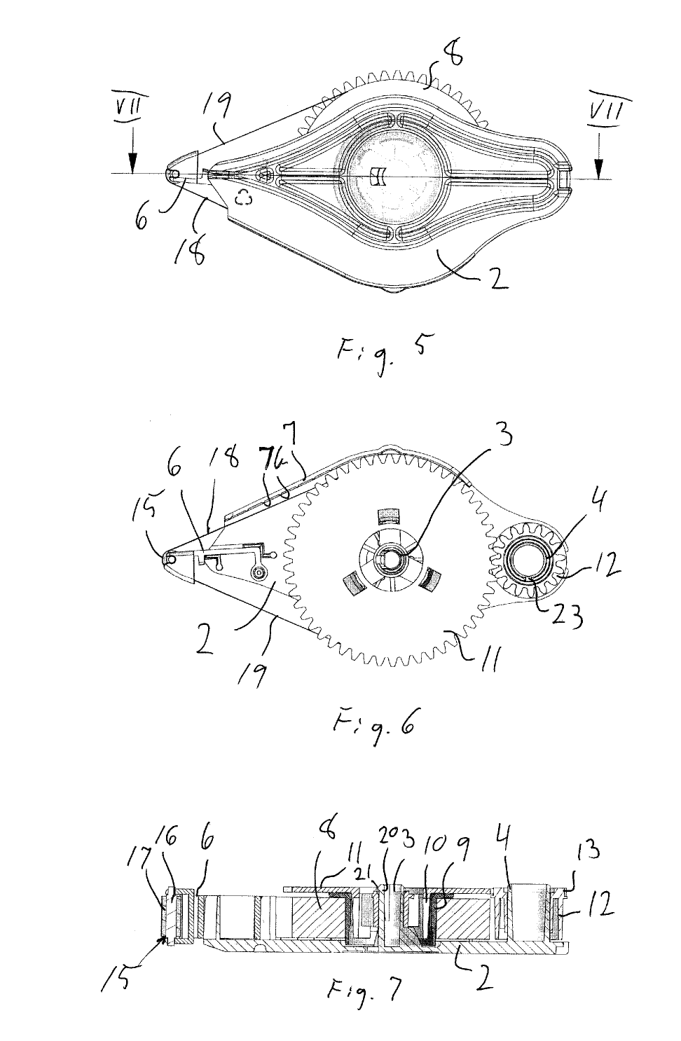

FIG. 6 is a view from the side opposite of FIG. 5,

FIG. 7 is a section along line VII-VII in FIG. 5,

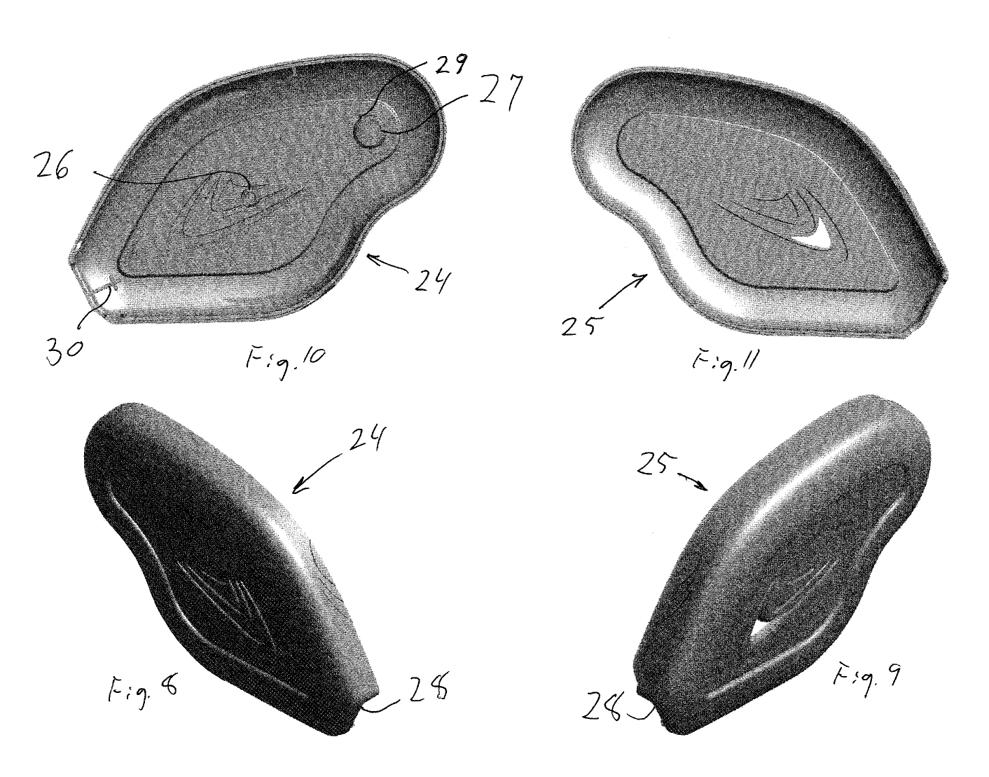

FIG. 8 is a perspective view of a first part of a housing,

FIG. 9 is a perspective view of a second part of the housing,

FIG. 10 is a plan view of the inside of the first part of the housing, and

FIG. 11 is a plan view of the inside of the second part of the housing.

The refill according to the present embodiment comprises a base element 1 with a generally flat base 2, from which two tubular pivots are extending, namely a supply pivot 3 and a take-up pivot 4. Also a protrusion 5 for carrying an applicator 6 is extending from the base 2, and a shielding 7 is extending along part of the edge of the base 2.

On the supply pivot 3 a supply roll 8 is rotatable mounted. The supply roll 8 comprises a roll of a carrier tape carrying an adhesive tape to be dispensed. The roll of carrier tape is wound on an outer hub member 9, which with a friction fit is position on an inner hub member 10. The inner hub member 10 is integral with a first gear wheel 11, which has a larger diameter than the roll of carrier tape.

On the take-up pivot 4 a take-up roll 12 is rotatable mounted. The take-up roll 12 is provided with a cogging 13 providing a second gear wheel engaging with the gear wheel 11 thus providing a transmission for torque from the supply roll 8 to the take-up roll 12, the friction fit between the outer and the inner hub member providing a slip clutch.

The applicator 6 is provided at a front end 14 of the base 2 and it has at its distal end an applicator roll 15 having a rigid core 16 and a resilient cylindrical jacket 17 thereon. The resilient jacket provides a resilient surface of the applicator roll 15.

The carrier tape extends from one side of the supply roll 8 through a first run 18 to the applicator 6, around the applicator roll 15 and through a second run 19 to the other side of the supply roll 8 and further to the take-up roll 12.

During use, whereby the applicator is pressed against a substrate and the dispenser is moved across that substrate, the carrier tape is, as it is known from the prior art, unwound from the supply roll 8, past around the applicator, whereby the adhesive tape is dispensed onto the substrate, and wound onto the take-up roll 12 thus providing a roll of spend carrier tape. The carrier tape thereby circumscribes a tape area generally defined by the supply roll 8, the first and the second run 18 and 19, the applicator roll 15, and the roll of spend carrier tape.

The base extends at the side of supply roll 8, from where the carrier tape is unwound, beyond the tape area and thus the shielding 7 extends outside the tape area to prevent a user from getting into contact with the adhesive, which is present on the outer peripheral side of the supply roll 8 and on the first run of the carrier tape. At the applicator the shielding 7 is not present in order not to prevent the intended function of the dispenser. The first gear wheel 11 cooperates with the shielding 7 to prevent contact with the adhesive. It should be noted that on the side of the supply roll 8 opposite to the side from where the carrier tape is unwound, the adhesive is shielded by the spend carrier tape running past the supply roll 8 to the take-up roll 12. This shielding by the spend carrier tape is provided for by the fact that the take-up roll 12 is positioned at the opposite end of the base 2 relative to the applicator 6 and the supply roll 8 is positioned intermediate the applicator 6 and the take-up roll 12.

The shielding 7 has transverse ribs 7b on its side facing the first run 18. Should the carrier tape become slack and the adhesive tape come in contact with the shielding, only the top of the ribs 7b will be in contact and the tape will not adhere too aggressively to the shielding 7. Thus the tape will easily be detached from the shielding again.

Being tubular the supply pivot 3 has a tubular wall. This is slit by two slits thus providing a flexible tongue 20, which has an outer projection 21. In order to mount or remove the supply roll 8 with all its hub parts the outer projection 21 and the flexible tongue must be pushed towards the centre of the supply pivot 3 the outer projection 21 otherwise restricting the movement of the innermost hub part.

The take-up pivot 4 has a wall with an inner cylindrical surface 22. By means of an axial recess 23 the inner cylindrical surface is made non-circular. This non-circularity has a function to be explained below.

The refill shown in FIGS. 1-7 and described so far is intended for inserting in a housing, which is shown in FIG. 9-11.

The housing comprises two parts, namely a bottom shell 24 and a top shell 25. The bottom shell 24 comprises two cylindrical pins, namely a supply pin 26 and a take-up pin 27 to receive the tubular supply pivot 3 and the tubular take-up pivot 4, respectively, when the refill is fitted into the bottom shell 24, base 2 up. The top shell 25 it fitted onto the bottom shell 24 and the refill is enclosed in the housing the applicator 6 extending through an opening provided by recesses 28 in a front end of the shells 24 and 25. Thus the adhesive tape dispenser is ready for use. The bottom shell 25 comprises a projection 30 for supporting the applicator 6.

The take-up pin 27 has a non-circular cross-section due to an axial protrusion 29, which must fit into the axial recess 23 in the inner cylindrical surface 22 of the take-up pivot 4. Thus only a refill with an axial recess corresponding to the axial protrusion 29 will fit into the housing. Thus the outside of the housing (shape, colour etc.) may signal a specific content of adhesive tape and only a refill containing that specific adhesive tape may fit into the housing. Thus it is avoided that a wrong refill may be fitted into a housing thus signalising a wrong content.

1. A refill for an adhesive tape dispenser, comprising a base carrying a tubular supply pivot, a tubular take-up pivot and an applicator, the applicator being positioned at a front end of the base, the take-up pivot being positioned at an opposite end of the base, and the supply pivot being positioned intermediate the applicator and the take-up pivot, the supply pivot carrying a supply roll of carrier tape carrying an adhesive tape to be dispensed, the take-up pivot carrying a take-up roll for spend carrier tape wherefrom the adhesive tape has been dispensed, the carrier tape extending from a first side of the supply roll, through a first run to the applicator, around the applicator, through a second run to the other side of the supply roll, past said other side and to the take-up roll, the supply roll, the first and second run, the applicator and the take-up roll defining in a projection on a plane parallel to the base a tape area, the base extending at least at the first side of the supply roll beyond the tape area, the base carrying at a part of its edge a shielding extending along a part of the first side of the supply roll and a part of the first run, each pivot having an end attached to the base and an opposite free end, the refill further comprising a transmission transmitting a torque from the supply roll to the take-up roll, said transmission including a slip clutch and said transmission comprising a first wheel, which is coaxial with the supply roll and has a larger radius than the supply roll, and a second wheel coaxial with the take-up roll, wherein said wheels are positioned at the free end of the respective pivot.

2. A refill according to claim 1, wherein said wheels are gear wheels having a circumferential cogging.

3. A refill according to claim 2, wherein the two wheels are intermeshing.

4. A refill according to claim 1, wherein the applicator is made as an independent element attached to the base.

5. A refill according to claim 1, wherein the applicator is provided with an applicator roll at its distal end for pressing the carrier tape against a substrate to dispense the adhesive tape onto the substrate, said applicator roll having a resilient surface.

6. A refill according to claim 1, wherein the first wheel is attached to an inner hub member carrying with a friction fit an outer hub member carrying the supply roll, thus providing the slip clutch.

7. A refill according to claim 1, wherein at least one of the tubular pivots has a tubular wall, said wall being slit from the free end to provide a flexible tongue, said tongue carrying at a free end an outer projection providing an obstruction for the respective roll.

8. A refill according to claim 1, wherein one of the tubular pivots has an inner cylindrical surface with a non-circular cross-section, e.g. provided by an axial recess in the cylindrical surface.

9. A housing for receiving a refill according to claim 1, said housing comprising two parts, one of which comprises two cylindrical pins for receiving the two pivots and a projection for supporting the applicator.

10. A housing for receiving a refill according to claim 8, said housing comprising two parts one of which comprises two cylindrical pins for receiving the two pivots and a projection for supporting the applicator, wherein one of the cylindrical pins has an outer cylindrical surface having a non-circular cross-section, e.g. provided by an axial protrusion on the cylindrical surface.
